(19) United States
(12) Patent Application Publication
(10) Pub. No.: US 2013/0063199 A1
(43) Pub. Date: Mar. 14, 2013

(54) PROGRAMMABLE COMPLEX MIXER

(71) Applicants: Seon-Ho HAN, Daejeon (KR); Hyun Ho Boo, Incheon (KR); Mun Yang Park, Daejeon (KR); Jang Hong Choi, Daejeon (KR); Hyun Kyu Yu, Daejeon (KR)

(72) Inventors: Seon-Ho HAN, Daejeon (KR); Hyun Ho Boo, Incheon (KR); Mun Yang Park, Daejeon (KR); Jang Hong Choi, Daejeon (KR); Hyun Kyu Yu, Daejeon (KR)

(73) Assignee: Electronics and Telecommunications Research Institute, Daejeon (KR)

(21) Appl. No.: 13/615,423

(22) Filed: Sep. 13, 2012

(30) Foreign Application Priority Data
Sep. 14, 2011 (KR) 10-2011-0092691
Sep. 13, 2012 (KR) 10-2012-0101370

(51) Int. Cl. G06G 7/14

(52) U.S. Cl. 327/355

(57) ABSTRACT

Disclosed is a programmable complex mixer. In accordance with the embodiments of the present invention, it is possible to control an output by programming paths and signs of internal signals in a complex mixer to reduce a processing bandwidth, power consumption, and a chip area in a transceiver, thereby improving performance of a transceiver.

### CROSS-REFERENCES TO RELATED APPLICATIONS

The present application claims priority under 35 U.S.C 119(a) to Korean Application Nos. 10-2011-0092691, filed on Sep. 14, 2011 and 10-2012-0101370, filed on Sep. 13, 2012 in the Korean Intellectual Property Office, which are incorporated herein by reference in its entirety set forth in full.

### BACKGROUND

Exemplary embodiments of the present invention relate to a programmable complex mixer, and more particularly, to a programmable complex mixer configured to program paths and signs of internal signals so as to control an output.

Generally, single-side band transmission and reception means rejecting any one of signals corresponding to the sum and difference of two signal frequencies that are output by mixing a carrier signal having any frequency with an input having another frequency.

There are various types of transceivers according to detailed technology types and applications. Among others, a transmitter using single-side up-conversion and a receiver using single-side band down-conversion have been mainly used.

First, among various types of transmitters, a phase locked loop (PLL) based structure has been most frequently used. In particular, the phase locked loop (PLL) structure has been mainly used in a global system for mobile communications (GSM) based transmitter that has used a Gaussian frequency shift keying (GFSK) modulation type and a Gaussian filtered minimum shift keying (GMSK) modulation type.

An example of another structure of the transmitter may include a structure of transmitting an I/Q signal in an RF band using an up-conversion mixer and has been mainly used in a code division multiple access (CDMA) based transmitter requiring linearity of a signal.

However, since a demand for the linearity of the signal is increased with the increased data transmission rate, a transmitter structure using the I/Q signal is the most basic structure.

Among the transmitter structures, a direct conversion structure that directly frequency-converts a baseband signal into an RF band has been most widely known as a combination with a frequency synthesizer that generates a large number of required RF channel center frequencies.

In addition, a structure of converting a frequency into an intermediate frequency (IF) band and then, converting the signal into a final RF band again according to applications has also been used.

There are various structures of receivers according to characteristics of a signal and applications. However, similar to the transmitter, a direct conversion structure or a structure of converting a frequency into an intermediate frequency (IF) band and then, converting the frequency into the final baseband has been mainly used.

Meanwhile, in order to up-convert or down-convert the frequency in the foregoing transmitter and receiver, a complex mixer has been frequently used.

The complex mixer basically means a mixer having a structure that can process a complex signal, but if the desired output results can be obtained by processing signals having a mutual orthogonal relationship, nay complex mixer may be used.

In case of the direct conversion, the single-side band transmission can be implemented if there is only a quadrature mixer. However, a more special structure is required when using the intermediate frequency (IF). The structure is illustrated in FIG. 1.

FIG. 1 is a block diagram for describing a configuration of a complex mixer in accordance with the related art.

As illustrated in FIG. 1, an apparatus including a complex mixer to perform signal processing is configured to an I/Q signal input unit 70, a complex mixer 80, and an I/Q signal processing unit 90.

The complex mixer 80 is configured into first, second, third, and fourth mixers 811, 812, 813, and 814 that convert an I signal and a Q signal transmitted from the I/Q signal input unit 70 into an intermediated frequency band, first and second adders 821 and 822 that perform an adding and subtracting operation of the signals, and an oscillator 830 that provides an oscillation signal for converting the I signal and the Q signal into the intermediate frequency band.

However, when performing single-side band transmission and reception using the complex mixer having the structure, there is a limitation in reducing a processing bandwidth, power consumption, and a chip area by processing the signals according to predetermined paths and signs so as to reject any one of the signals.

The above-mentioned technical configuration is a background art for helping understanding of the present invention and does not mean related arts well known in a technical field to which the present invention pertains.

### SUMMARY

An embodiment of the present invention is directed to a programmable complex mixer capable of improving performance of a transceiver by being configured to program paths and signs of internal signals in the complex mixer so as to control an output.

An embodiment of the present invention relates to a programmable complex mixer including: a mixer unit configured to frequency-convert an I signal and a Q signal input from an I/Q signal input unit according to an oscillation signal generated from an oscillator; an operation unit configured to generate an output by adding or subtracting the I signal and the Q signal input from the mixer unit; and an I/Q signal shifting unit configured to control paths and signs of the I signal and the Q signal input to the mixer unit or the operation unit according to I/Q control signals.

The I/Q signal shifting unit may be inserted between the I/Q signal input unit and the mixer unit.

The I/Q signal shifting unit may be inserted between the mixer unit and the operation unit.

The operation unit may selectively add or subtract the I signal and the Q signal input from the I/Q signal shifting unit according to an operation control signal.

The programmable complex mixer may further include: an oscillation signal shifting unit configured to control the paths and signs of the oscillation signal according to an oscillation control signal and provide the controlled oscillation signal to the mixer unit.

The oscillation signal shifting unit may be inserted between the oscillator and the mixer unit.

Another embodiment of the present invention relates to a programmable complex mixer, including: a first I/Q signal shifting unit configured to control paths and signs of an I signal and a Q signal input from an I/Q signal input unit according to a first I/Q control signal; an oscillation signal shifting unit configured to control the paths and signs of an oscillation signal generated by an oscillator according to an oscillation control signal; a mixer unit configured to frequency-convert the I signal and the Q signal input from the first I/Q signal shifting unit according to the oscillation signal input from the oscillation signal shifting unit; a second I/Q signal shifting unit configured to control the paths and signs of the I signal and the Q signal frequency-converted by the mixer unit according to a second I/Q control signal; and an operation unit configured to generate an output by adding or subtracting the signal output from the second I/Q signal shifting unit according to an operation control signal.

The output may be controlled by at least one of the first I/Q control signal, the second I/Q control signal, the oscillation control signal, and the operation control signal.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram for describing a configuration of a complex mixer in accordance with the related art;

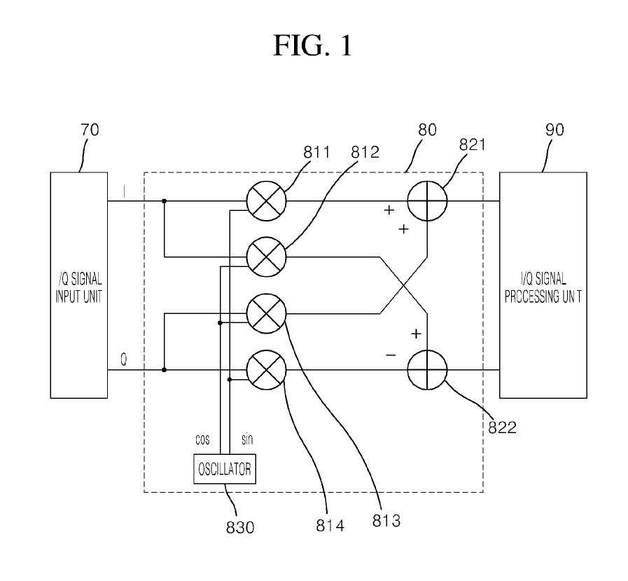

FIG. 2 is a block diagram illustrating a configuration of a programmable complex mixer in accordance with an embodiment of the present invention; and

FIG. 3 is a diagram for describing improvement in performance of a transceiver using a programmable complex mixer in accordance with an embodiment of the present invention.

### DESCRIPTION OF SPECIFIC EMBODIMENTS

Hereinafter, a programmable complex mixer in accordance with embodiments of the present invention will be described in detail with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

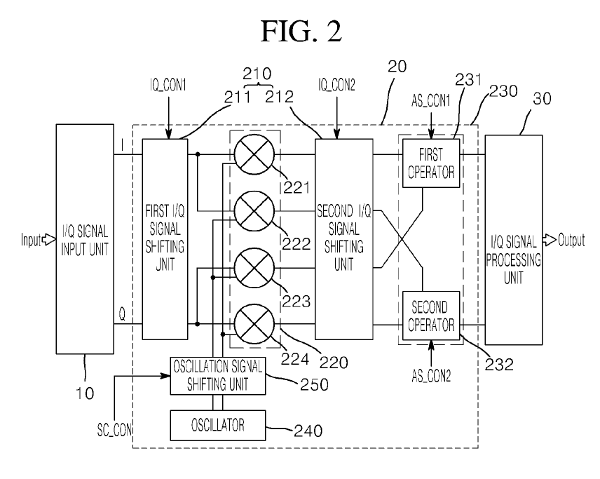

FIG. 2 is a block diagram illustrating a configuration of a programmable complex mixer in accordance with an embodiment of the present invention.

As illustrated in FIG. 2, a programmable complex mixer 20 in accordance with one embodiment of the present invention includes an I/Q signal shifting unit 210, a mixer unit 220, an operation unit 230, an oscillator 240, and an oscillation signal shifting unit 250.

The I/Q signal input unit 10 generates an I signal and a Q signal that are a mutual orthogonal relationship from an input and provides the generated I and Q signals to the complex mixer 20.

The I/Q signal shifting unit 210 of the complex mixer 20 may control the paths and signs of the I signal and the Q signal and may include a first I/Q signal shifting unit 211 and a second I/Q signal shifting unit 212.

The first I/Q signal shifting unit 211 controls the paths and signs of the I and Q signals that are input from the I/Q signal input unit 10 according to a first I/Q control signal IQ_CON1 and outputs the controlled I and Q signals to the mixer unit 220.

That is, the first I/Q signal shifting unit 211 may be inserted between the I/Q signal input unit 10 and the mixer unit 220 to change the paths of the I signal and the Q signal from each other and output the changed I and Q signals or change the signs of the I signal or the Q signal from (+) to (−) or from (−) to (+) and output the changed I signal or Q signal.

The second I/Q signal shifting unit 212 is inserted between the mixer unit 220 and the operation unit 230 to perform the same function with the first I/Q signal shifting unit 211 and the detailed description thereof will be described.

The oscillator 240 generates an oscillation signal having an oscillation frequency.

In this case, the oscillator 240 may generate two oscillation signals (for example: COS, SIN) having the mutual orthogonal relationship.

The oscillation signal shifting unit 250 controls the path and sign of the oscillation signal generated by the oscillator 240 according to an oscillation control signal SC_CON and provides the controlled oscillation signal to the mixer unit 220.

That is, the oscillation signal shifting unit 250 may be inserted between the oscillator 240 and the mixer unit 220 to change the paths of the two oscillation signals having the mutual orthogonal relationship from each other and output the changed oscillation signals or change the signs of the two oscillation signals from (+) to (−) or from (−) to (+) and output the changed oscillation signals.

The mixer unit 220 mixes the I signal and the Q signal input from the first I/Q signal shifting unit 20 with the oscillation signal input from the oscillation signal shifting unit 250 to perform the frequency up-conversion or the frequency down-conversion.

The mixer unit 220 may perform the up-conversion when transmitting the signal and may perform the down-conversion when receiving the signal.

Referring to FIG. 2, the mixer unit 220 may include first, second, third, and fourth four mixers 221, 222, 223, and 224 so as to mix the two oscillation signals, respectively, in the I signal and the Q signal input from the first I/Q signal shifting unit 211.

The second I/Q signal shifting unit 212 controls the paths and signs of the I signal and the Q signal input from the mixer unit 220 according to the second I/Q control signal IQ_CON2 and outputs the controlled I and Q signals to the operation unit 230.

That is, the second I/Q signal shifting unit 212 may be inserted between the mixer unit 220 and the operation unit 230 to change the paths of the I signal and the Q signal from each other and output the changed I and Q signals or change the signs of the I signal or the Q signal from (+) to (−) or from (−) to (+) and output the changed I signal or Q signal.

The operation unit 230 performs the adding or subtracting operation on two of the signals input from the second I/Q signal shifting unit 212.

As illustrated in FIG. 2, when the mixer unit 220 includes the first, second, third, and fourth mixers 221, 222, 223, and 224, the operation unit 230 may include first and second operators 231 and 233 and the first and second operators 231 and 232 each may selectively perform the adding or subtracting operation according to first and second operation control signals AS_CON1 and AS_CON2.

When the first operator 231 performs the summing operation, the second operator 232 may perform the subtracting operation according to the first and second operation control signals AS_CON1 and AS_CON2.

On the other hand, when the first operator 231 performs the subtracting operation, the second operator 232 may perform the summing operation according to the first and second operation control signals AS_CON1 and AS_CON2.

Meanwhile, the signals output from the first and second operators 231 and 232 are input to the I/Q signal processing unit 30 and are subjected to the signal processing and then, are output as an final output.

As such, the programmable complex mixer in accordance with the embodiment of the present invention may be configured to program the paths and signs of the internal signals based on the first and second I/Q control signals IQ_CON1 and IQ_CON2, the oscillation control signal SC_CON, and the first and second operation control signals AS_CON1 and AS_CON2 to control the final output.

As such, the processing bandwidth of the transceiver can be reduced and the power consumption and the chip area can be reduced, by programming the paths and signs of the internal signal, thereby improving the performance of the transceiver.

Meanwhile, the embodiment of the present invention describes, for example, the case in which all of the first I/Q signal shifting unit 211, the second I/Q signal shifting unit 212, and the oscillation signal shifting unit 250 are included in the complex mixer 20, but the foregoing components may be selectively included, if necessary.

Further, even though all of the first I/Q signal shifting unit 211, the second I/Q signal shifting unit 212, and the oscillation signal shifting unit 250 are included in the complex mixer 20, the final output can be controlled based on only the part thereof.

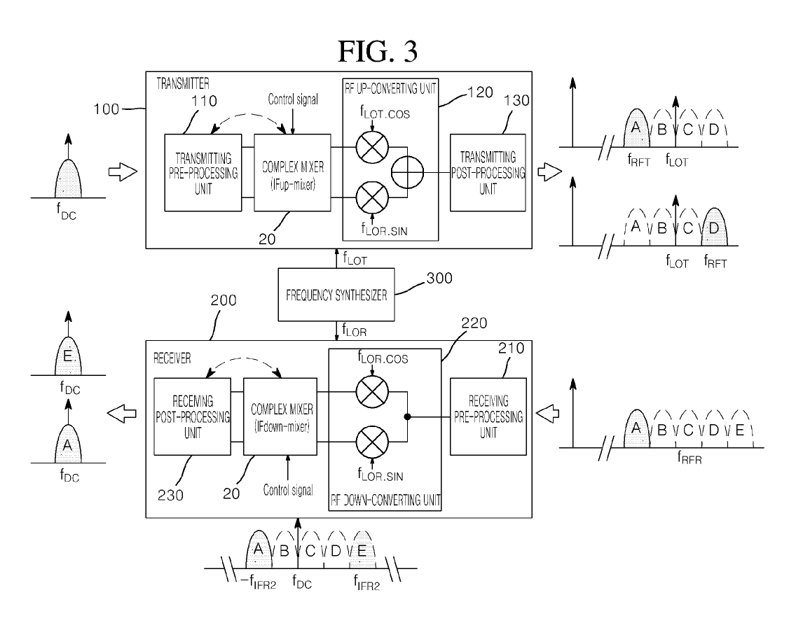

FIG. 3 is a diagram for describing the improvement in the performance of the transceiver using the programmable complex mixer in accordance with the embodiment of the present invention. FIG. 3 illustrates a configuration of the transmitter 100 and the receiver 200 to which the complex mixer 20 in accordance with the embodiment of the present invention is applied.

As illustrated in FIG. 3, the transmitter 100 using the programmable complex mixer in accordance with the embodiment of the present invention is configured to include a transmitting pre-processing unit 110, the complex mixer 20, an RF up-converting unit 120, and a transmitting post-processing unit 130.

When the transmitting pre-processing unit 110 processes a signal f_{DC} in a baseband, the complex mixer 20 up-converts the signal f_{DC} in the baseband into the intermediate frequency (IF) band.

In this case, the detailed configuration and functions of the transmitting pre-processing unit 110 and the complex mixer 20 may be variously selected according to the design type of the transmitter 100.

First, when the transmitting pre-processing unit 110 and the complex mixer 20 are designed based on an analog based design type, the transmitting pre-processing unit 110 is configured to perform functions such as digital-to-analog converting (DAC), filtering, variable gain amplifying, and the like.

In this case, the complex mixer 20 is designed based on analog and performs the intermediate frequency (IF) up-conversion in an analog signal region.

Second, the transmitting pre-processing unit 110 is designed based on an analog based design type and thus, may perform a part of the foregoing functions and the complex mixer 20 is designed based on a digital based design type and thus, may also be located at a front stage of the transmitting pre-processing unit 110.

In this case, the complex mixer 20 performs the intermediate frequency (IF) up-conversion in the digital signal region and further performs functions such as digital filtering, up-sampling, and the like, so as to perform the signal processing.

In addition, in the case of the second structure, a part of the functions of the transmitting pre-processing unit 110 is removed or the transmitting pre-processing unit 110 may also be designed to be coupled with the RF up-converting unit 120 of the next stage. The structure is referred to as a direct RF converter (DRFC).

According to the DRFC structure, the signal in the digital region may directly be converted into the analog signal.

The RF up-converting unit 120 frequency-converts the signals converted into the intermediate frequency (IF) band into the RF band and combines the I/Q signals to implement the single-side band transmission.

In this case, an oscillation signal f_{LOT} supplied to the mixer included in the RF up-converting unit 120 is provided from a frequency synthesizer 300.

When the complex mixer 20 varies the center frequency of the transmitting signal and converts the center frequency of the transmitting signal into the intermediate frequency (IF) band, the frequency synthesizer 300 cannot vary the oscillation signal f_{LOT} into various types.

To the contrary, when the complex mixer 20 does not vary the center frequency of the transmitting signal, the frequency synthesizer 300 need to synthesize various oscillation signals f_{LOT}.

The transmitting post-processing unit 130 amplifies, filters, and outputs the signal in the RF band converted by the RF up-converting unit 120.

When the complex mixer 20 for the intermediate frequency (IF) up-conversion is used, the input and output relationship of the signal is illustrated in FIG. 3.

The complex mixer 20 in accordance with the embodiment of the present invention may control the paths and signs of the internal signals to control the output, as described above.

In detail, the complex mixer 20 may control the paths and signs of the I/Q signals and the oscillation signal according to the first and second control signals IQ_CON1 and IQ_CON2, the oscillation control signal SC_CON, and the first and second operation control signals AS_CON1 and AS_CON2 to selectively perform the adding or subtracting operation.

Therefore, as illustrated in FIG. 3, when the signal f_{DC} in the baseband having any bandwidth is input, the transmission frequency band of the final output f_{RFT} may be freely selected at any one of bands A, B, C, and D based on the frequency of the oscillation signal f_{LOT}.

In more detail, when intending to perform the transmission in the band B or C during the transmission in band A or D, the transmitting frequency band may be controlled by varying the oscillation frequency of the oscillator 240 of the complex mixer 20 or the output frequency of the frequency synthesizer 300.

In addition, when intending to perform the transmission in the band C or D during the transmission in band A or D, the transmitting frequency band can be controlled by controlling the paths and signs of the internal signals based on the first and second I/Q control signals IQ_CON1 and IQ_CON2, the oscillation control signal SC_CON, and the first and second operation control signals AS_CON1 and AS_CON2.

As such, in case in which being configured to program the complex mixer 20, as compared with the related art performing the single-side band transmission to only any one side based on the oscillation signal f_{LOT}, the bandwidth to be processed in the intermediate frequency IF band may be reduced to about ½.

In addition, when the complex mixer 20 is designed in a digital type and is located at the front stage of the transmitting pre-processing unit 100, the sampling frequency for processing the digital signal can be considerably reduced and therefore, the power consumption and the chip area can be reduced.

Meanwhile, the receiver 200 using the programmable complex mixer in accordance with the embodiment of the present invention is configured to include the receiving pre-processing unit 210, the RF down-converting unit 220, the complex mixer 20, and the receiving post-processing unit 230.

The receiving pre-processing unit 210 amplifies, filters, and outputs the signal f_{RFR} in the RF band.

The RF down-converting unit 220 converts the signal f_{RFR} in the RF band input from the receiving pre-processing unit 210 into the intermediate frequency (IF) band.

The complex mixer 20 converts the signal converted into the intermediate frequency (IF) band by the RF down-converting unit 220 into the signal f_{DC} in the baseband. In this case, the complex mixer 20 may perform the single-side band down-conversion.

The complex mixer 20 in accordance with the embodiment of the present invention may program the paths and signs of the internal signals. Therefore, the complex mixer 20 may down-convert even the signal in any band such as A, B, C, D, E, and the like, of FIG. 3 into the baseband, based on the first and second I/Q control signals IQ_CON1 and IQ_CON2, the oscillation control signal SC_CON, and the first and second operation control signals AS_CON1 and AS_CON2.

The receiving post-processing unit 230 performs the functions such as the analog-to-digital converting (ADC), the filtering, the variable gain amplifying, and the like.

Further, similar to the transmitter 100, the receiving post-processing unit 230 and the complex mixer 20 may be designed by changing their own positions.

When the receiving post-processing unit 230 is located at the next stage of the complex mixer 20, the complex mixer 20 is designed based on the analog type and when the receiving post-processing unit 230 is located at the front stage of the complex mixer 20, the complex mixer 20 may be designed based on the digital type.

In accordance with the embodiments of the present invention, it is possible to control the output by programming the paths and signs of the internal signals in the programmable complex mixer to reduce the processing bandwidth, the power consumption, and the chip area in the transceiver, thereby improving the performance of the transceiver.

Although the embodiments of the present invention have been described in detail, they are only examples. It will be appreciated by those skilled in the art that various modifications and equivalent other embodiments are possible from the present invention. Therefore, the technical protection scope of the present invention should be defined by the appended claims.

What is claimed is:

1. A programmable complex mixer, comprising:
a mixer unit configured to frequency-convert an I signal and a Q signal input from an I/Q signal input unit according to an oscillation signal generated from an oscillator;
an operation unit configured to generate an output by adding or subtracting the I signal and the Q signal input from the mixer unit; and
an I/Q signal shifting unit configured to control paths and signs of the I signal and the Q signal input to the mixer unit or the operation unit according to I/Q control signals.

2. The programmable complex mixer of claim 1, wherein the I/Q signal shifting unit is inserted between the I/Q signal input unit and the mixer unit.

3. The programmable complex mixer of claim 1, wherein the I/Q signal shifting unit is inserted between the mixer unit and the operation unit.

4. The programmable complex mixer of claim 3, wherein the operation unit selectively adds or subtracts the I signal and the Q signal input from the I/Q signal shifting unit according to an operation control signal.

5. The programmable complex mixer of claim 1, further comprising:
an oscillation signal shifting unit configured to control the paths and signs of the oscillation signal according to an oscillation control signal and provide the controlled oscillation signal to the mixer unit.

6. The programmable complex mixer of claim 5, wherein the oscillation signal shifting unit is inserted between the oscillator and the mixer unit.

7. A programmable complex mixer, comprising:
a first I/Q signal shifting unit configured to control paths and signs of an I signal and a Q signal input from an I/Q signal input unit according to a first I/Q control signal;
an oscillation signal shifting unit configured to control the paths and signs of an oscillation signal generated by an oscillator according to an oscillation control signal;
a mixer unit configured to frequency-convert the I signal and the Q signal input from the first I/Q signal shifting unit according to the oscillation signal input from the oscillation signal shifting unit;
a second I/Q signal shifting unit configured to control the paths and signs of the I signal and the Q signal frequency-converted by the mixer unit according to a second I/Q control signal; and
an operation unit configured to generate an output by adding or subtracting the signal output from the second I/Q signal shifting unit according to an operation control signal.

8. The programmable complex mixer of claim 7, wherein the output is controlled by at least one of the first I/Q control signal, the second I/Q control signal, the oscillation control signal, and the operation control signal.
